(19) United States
(12) Patent Application Publication
(10) Pub. No.: US 2023/0342175 A1
(43) Pub. Date: Oct. 26, 2023

(54) INTELLIGENT CAPACITY PLANNING BASED ON WHAT-IF OPERATIONS FOR STORAGE IN A HYPERCONVERGED INFRASTRUCTURE

(71) Applicant: VMware, Inc., Palo Alto, CA (US)

(72) Inventors: Yang YANG, Shanghai (CN); Yang YANG, Shanghai (CN); Sixuan YANG, Shanghai (CN); Jin FENG, Shanghai (CN)

(73) Assignee: VMware, Inc., Palo Alto, CA (US)

(21) Appl. No.: 17/727,833

(22) Filed: Apr. 25, 2022

(51) Int. Cl. G06F 9/455

(52) U.S. Cl. CPC G06F 9/45558; G06F 9/45545; G06F 2009/45583; G06F 2009/4557; G06F 2009/45591

(57) ABSTRACT

Intelligent capacity planning is provided for storage in a hyperconverged infrastructure environment. The storage may be a logical storage unit that is supported by storage space of a plurality of hardware disks in a virtualized computing environment. Failure predictions can be obtained for each individual hardware disk, and a failure prediction for a number of hardware disk in a hardware disk set can also be obtained. A failure prediction and/or a reduced availability prediction for the logical storage unit can be generated based at least on a configuration state of the logical storage unit, a prediction for one or more hardware disks of the logical storage unit, and a prediction time. Predictions based on what-if operations are also able to be generated.

### CROSS-REFERENCE TO RELATED APPLICATION

The present application (Attorney Docket No. H986.02) is related in subject matter to U.S. patent application Ser. No. ______ (Attorney Docket No. H986.01), entitled “INTELLIGENT CAPACITY PLANNING FOR STORAGE IN A HYPERCONVERGED INFRASTRUCTURE,” which is incorporated herein by reference.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

A software-defined approach may be used to create shared storage for VMs and/or for some other types of entities, thereby providing a distributed storage system in a virtualized computing environment. Such software-defined approach virtualizes the local physical storage resources of each of the hosts and turns the storage resources into pools of storage that can be divided and accessed/used by VMs or other types of entities and their applications. The distributed storage system typically involves an arrangement of virtual storage nodes or logical storage units that communicate data with each other and with other devices.

One type of virtualized computing environment that uses a distributed storage system is a hyperconverged infrastructure (HCI) environment, which combines elements of a traditional data center: storage, compute, networking, and management functionality. Capacity planning, prediction, and simulation (which all may be generally considered to be part of capacity planning) are important for an HCI storage environment, such as for configuration and monitoring purposes. For example, system administrators may rely on capacity planning techniques to plan procurement cycles for new and/or additional storage resources and to schedule maintenance windows. Site reliability engineers (SREs) also use capacity planning techniques to try to prevent a potential data loss or a performance downgrade, so as to achieve service level agreement (SLA) or service level objective (SLO) targets.

However, due to the complexities associated with storage resources in a HCI environment, capacity planning can be challenging. Existing capacity planning techniques (including techniques used for traditional storage environments) are inadequate, ineffective, or inefficient.

### BRIEF DESCRIPTION OF DRAWINGS

FIG. 1 is a schematic diagram illustrating an example virtualized computing environment that can implement an intelligent storage capacity planning technique;

FIG. 2 is a schematic diagram illustrating example workflows for storage capacity planning for the virtualized computing environment of FIG. 1;

FIG. 3 is a schematic diagram showing an example training workflow for hardware disk failure prediction;

FIG. 4 is flowchart of an example method to predict failure of a disk set in the virtualized computing environment of FIGS. 1 and 2;

FIG. 5 is a flowchart of an example method to predict failure of a logical storage unit in the virtualized computing environment of FIGS. 1 and 2;

FIG. 6 is a flowchart of an example method to predict failure of a logical storage unit in a reconfiguration state in the virtualized computing environment of FIGS. 1 and 2;

FIG. 7 is a flowchart showing an example of a method to predict the failure of a logical storage unit in a resynchronization state in the virtualized computing environment of FIGS. 1 and 2; and

FIG. 8 is a flowchart showing an example of a method to predict the failure of a logical storage unit based on what-if operations in the virtualized computing environment of FIGS. 1 and 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be implemented in connection with other embodiments whether or not explicitly described.

The present disclosure addresses various drawbacks associated with performing capacity planning for storage resources, such as distributed storage or other logical arrangement of storage resources (e.g., logical storage units) in a hyperconverged infrastructure (HCI) environment. For instance, the embodiments of intelligent capacity planning techniques disclosed herein address drawbacks such as difficulty in predicting failures of logical storage units, difficulty in predicting data inaccessibility during changes in topology of logical storage units, and lack of reliable what-if prediction capability for logical storage units in an HCI environment.

With regards to difficulties in predicting failures of logical storage resources in an HCI environment, conventional storage prediction models typically focus on a failure prediction for a single hardware disk. However, storage resources in an HCI environment are often configured with a high level of redundancy, such as by using redundant array of independent disk (RAID) policies/components, so as to be tolerant of single points of failure. For example, a single hardware disk failure does not typically result in a failure of a logical storage unit in the HCI environment, if a storage policy with adequate redundancy has been properly configured. However, if multiple hardware disk failures happen at the same time window, existing capacity planning techniques are unable to sufficiently mitigate the risk of data loss. Concurrent hardware disk failures may occur, for instance, in a user/customer environment in which the hardware disks are purchased/installed at the same procurement cycle and the hardware disks experience similar input/output (I/O) workload. Therefore, there is greater likelihood that multiple hardware disks can start to fail at around the same timeframe (e.g., double, triple, etc. failure).

With regards to difficulties in predicting data inaccessibility during changes in topology of logical storage units, such difficulties are often encountered in HCI environments when data is replicated on multiple hardware disks and/or logical storage units for redundancy purposes. For example, a piece of data (e.g., contained in a storage object) may be replicated on two different disks. After a first disk has failed, the replica on the second disk is synchronized with the latest data, which is called a data resynchronization or resynch process. During the resync process, the storage object is vulnerable since only one intact copy of data is in existence. Unfortunately, conventional capacity planning techniques do not provide capabilities to predict the inaccessibility of storage objects during a resynch process. This lack of capability to predict data inaccessibility also applies to other types of topology changes that affect a storage object, such as a policy change (e.g., changing from RAID 1 configuration to a RAID 5 or RAID 6 configuration) or other topological change in a logical storage unit that affects the accessibility of data stored in the logical storage unit. The embodiments of the capacity planning techniques described herein provide capability to predict data inaccessibility in the context of topological changes, so as to enable users (such as system administrators) to more effectively plan the right maintenance window(s), for instance by suggesting proactive hardware replacements before any data movement.

With regards to the lack of reliable what-if prediction capability for logical storage units, what-if predictions enable the users to determine the impact of a configuration operation without actually performing the configuration operation. Conventional what-if prediction techniques in an HCI environment are limited in that such conventional techniques only provide predictions on basic capacity and storage accessibility. Embodiments of the capacity planning techniques disclosed herein advantageously provide users with more extensive what-if predictions/simulations for various operations such as placing a host into a maintenance mode, replacing a disk, etc., so as to evaluate the impact of these operations before such operations are performed.

Accordingly, the embodiments disclosed herein provide intelligent capacity planning for storage (or for other types of logical resources) in a hyperconverged infrastructure environment. The storage may be a logical storage unit that is supported by storage space of a plurality of hardware disks in a virtualized computing environment. Failure predictions can be obtained for each individual hardware disk, and a failure prediction for a number of hardware disk in a hardware disk set can also be obtained. A failure prediction and/or a reduced availability prediction for the logical storage unit can be generated based at least on a configuration state of the logical storage unit, the failure prediction for a number of hardware disks in the logical storage unit, and a prediction time. Predictions for impacts of what-if operations are also able to be generated based at least in part on the failure prediction for the number of hardware disks.

Computing Environment

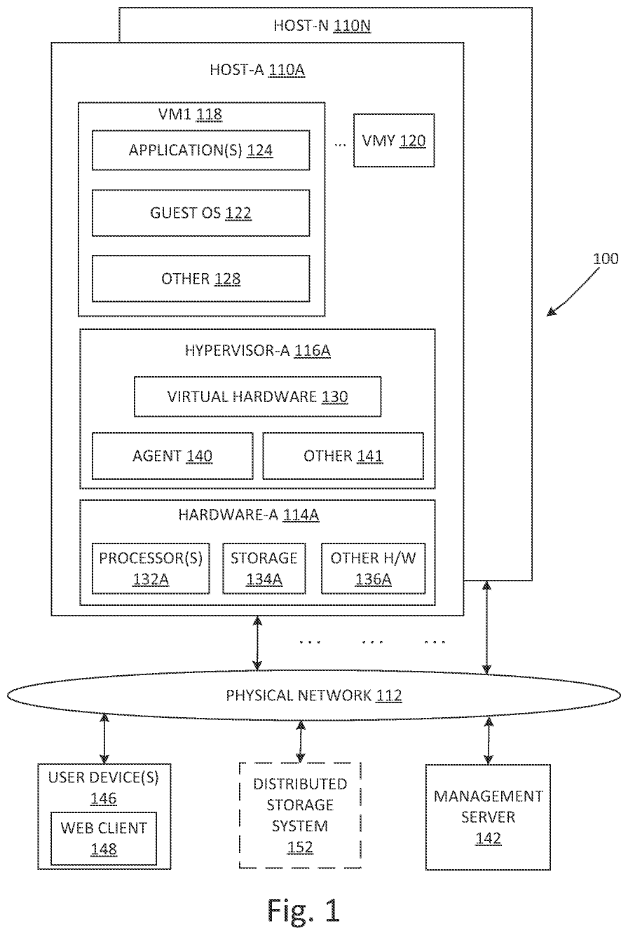

Various implementations will now be explained in more detail using FIG. 1, which is a schematic diagram illustrating an example virtualized computing environment 100 that can implement an intelligent storage capacity planning technique. Depending on the desired implementation, the virtualized computing environment 100 may include additional and/or alternative components than that shown in FIG. 1. The virtualized computing environment 100 may comprise parts of a data center or other internal network (e.g., a customer/user environment that includes hyperconverged storage or other forms of distributed/logical storage).

In the example in FIG. 1, the virtualized computing environment 100 includes multiple hosts, such as host-A 110A . . . host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of host-A 110A. Each of the other hosts can include substantially similar elements and features.

The host-A 110A includes suitable hardware-A 114A and virtualization software (e.g., hypervisor-A 116A) to support various virtual machines (VMs). For example, the host-A 110A supports VM1 118 . . . VMY 120, wherein Y (as well as N) is an integer greater than or equal to 1. In practice, the virtualized computing environment 100 may include any number of hosts (also known as “computing devices”, “host computers”, “host devices”, “physical servers”, “server systems”, “physical machines,” etc.), wherein each host may be supporting tens or hundreds of virtual machines. For the sake of simplicity, the details of only the single VM1 118 are shown and described herein.

VM1 118 may include a guest operating system (OS) 122 and one or more guest applications 124 (and their corresponding processes) that run on top of the guest operating system 122. VM1 118 may include still further other elements 128, such as a virtual disk, agents, engines, modules, and/or other elements usable in connection with operating VM1 118.

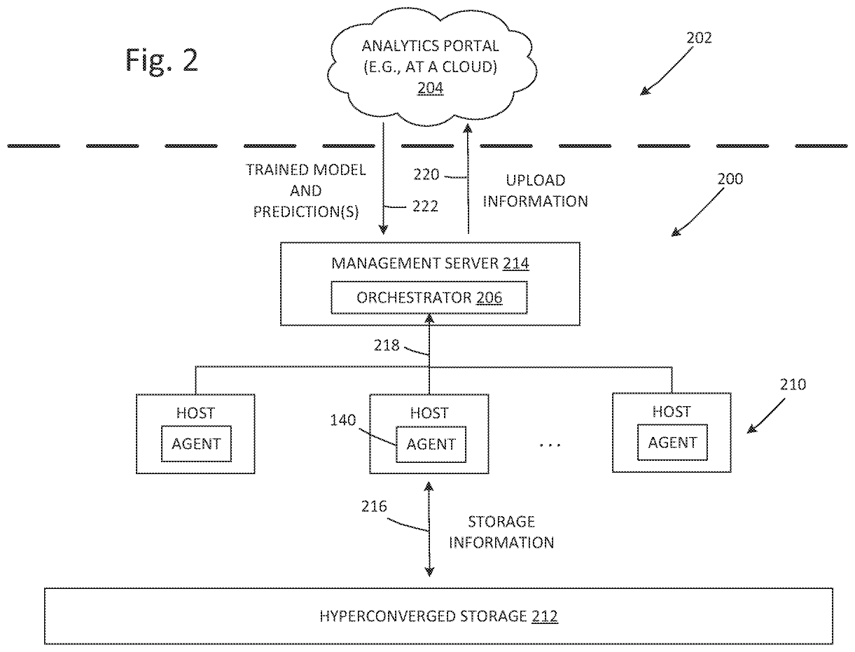

The hypervisor-A 116A may be a software layer or component that supports the execution of multiple virtualized computing instances. The hypervisor-A 116A may run on top of a host operating system (not shown) of the host-A 110A or may run directly on hardware-A 114A. The hypervisor-A 116A maintains a mapping between underlying hardware-A 114A and virtual resources (depicted as virtual hardware 130) allocated to VM1 118 and the other VMs. The hypervisor-A 116A of some implementations may include/run one or more monitoring agents 140, which may collect host-level and/or cluster-level information, such as performance metrics indicative of storage capacity/usage, processor load, network performance, or other statistics/data/information pertaining to the customer environment. In some implementations, the agent 140 may reside elsewhere in the host-A 110A (e.g., outside of the hypervisor-A 116A). The agent 140 of various embodiments is configured to provide the collected environment information to a management server 142 which in turn may provide the information to an analytics portal, such as will be described later below with respect to FIG. 2.

The hypervisor-A 116A may include or may operate in cooperation with still further other elements 141 residing at the host-A 110A. Such other elements 141 may include drivers, agent(s), daemons, engines, virtual switches, and other types of modules/units/components that operate to support the functions of the host-A 110A and its VMs, as well as functions associated with using storage resources of the host-A 110A for distributed storage.

Hardware-A 114A includes suitable physical components, such as CPU(s) or processor(s) 132A; storage resources(s) 134A; and other hardware 136A such as memory (e.g., random access memory used by the processors 132A), physical network interface controllers (NICs) to provide network connection, storage controller(s) to access the storage resources(s) 134A, etc. Virtual resources (e.g., the virtual hardware 130) are allocated to each virtual machine to support a guest operating system (OS) and application(s) in the virtual machine, such as the guest OS 122 and the applications 124 in VM1 118. Corresponding to the hardware-A 114A, the virtual hardware 130 may include a virtual CPU, a virtual memory, a virtual disk, a virtual network interface controller (VNIC), etc.

Storage resource(s) 134A may be any suitable physical storage device that is locally housed in or directly attached to host-A 110A, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, integrated drive electronics (IDE) disks, universal serial bus (USB) storage, etc. The corresponding storage controller may be any suitable controller, such as redundant array of independent disks (RAID) controller (e.g., RAID 1 configuration), etc.

A distributed storage system 152 may be connected to each of the host-A 110A . . . host-N 110N that belong to the same cluster of hosts. For example, the physical network 112 may support physical and logical/virtual connections between the host-A 110A . . . host-N 110N, such that their respective local storage resources (such as the storage resource(s) 134A of the host-A 110A and the corresponding storage resource(s) of each of the other hosts) can be aggregated together to form a shared pool of storage in the distributed storage system 152 that is accessible to and shared by each of the host-A 110A . . . host-N 110N, and such that virtual machines supported by these hosts may access the pool of storage to store data. In this manner, the distributed storage system 152 is shown in broken lines in FIG. 1, so as to symbolically convey that the distributed storage system 152 is formed as a virtual/logical arrangement of the physical storage devices (e.g., the storage resource(s) 134A of host-A 110A) located in the host-A 110A . . . host-N 110N. However, in addition to these storage resources, the distributed storage system 152 may also include stand-alone storage devices that may not necessarily be a part of or located in any particular host.

According to some implementations, two or more hosts may form a cluster of hosts that aggregate their respective storage resources to form the distributed storage system 152. The aggregated storage resources in the distributed storage system 152 may in turn be arranged as a plurality of virtual storage nodes. Other ways of clustering/arranging hosts and/or virtual storage nodes are possible in other implementations.

The management server 142 (or other network device configured as a management entity) of one embodiment can take the form of a physical computer or with functionality to manage or otherwise control the operation of host-A 110A . . . host-N 110N, including operations associated with the distributed storage system 152. In some embodiments, the functionality of the management server 142 can be implemented in a virtual appliance, for example in the form of a single-purpose VM that may be run on one of the hosts in a cluster or on a host that is not in the cluster of hosts. The management server 142 may be operable to collect usage data associated with the hosts and VMs, to configure and provision VMs, to activate or shut down VMs, to monitor health conditions and diagnose/troubleshoot and remedy operational issues that pertain to health, and to perform other managerial tasks associated with the operation and use of the various elements in the virtualized computing environment 100 (including managing the operation of and accesses to the distributed storage system 152, including capacity planning related operations for the distributed storage system 152).

The management server 142 may be a physical computer that provides a management console and other tools that are directly or remotely accessible to a system administrator or other user. The management server 142 may be communicatively coupled to host-A 110A . . . host-N 110N (and hence communicatively coupled to the virtual machines, hypervisors, hardware, distributed storage system 152, etc.) via the physical network 112. In some embodiments, the functionality of the management server 142 may be implemented in any of host-A 110A . . . host-N 110N, instead of being provided as a separate standalone device such as depicted in FIG. 1.

A user may operate a user device 146 to access, via the physical network 112, the functionality of VM1 118 . . . VMY 120 (including operating the applications 124), using a web client 148. The user device 146 can be in the form of a computer, including desktop computers and portable computers (such as laptops and smart phones). In one embodiment, the user may be an end user or other consumer that uses services/components of VMs (e.g., the application 124) and/or the functionality of the distributed storage system 152. The user may also be a system administrator that uses the web client 148 of the user device 146 to remotely communicate with the management server 142 via a management console for purposes of performing management operations, including management operations related to the distributed storage system 152 such as installing/provisioning additional storage resources during procurement cycles in response to capacity planning results, configuring logical storage units or other distributed/virtual arrangements of physical/hardware disks and other storage resources, performing troubleshooting of storage resources, etc.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

Workflows for Intelligent Capacity Planning of Storage Resources

FIG. 2 is a schematic diagram illustrating example workflows for storage capacity planning for the virtualized computing environment 100 of FIG. 1. With respect to the workflows of FIG. 2 and/other processes/methods, apparatus/devices, systems, etc. described throughout this disclosure, the terms logical storage unit and prediction time are used in connection with the description of various embodiments. A logical storage unit may be a logical/virtual storage resource for storing data of a user/consumer. Examples of a logical storage unit may be a storage object such as a virtual machine disk (VMDK) file, a file in a file system, a raw disk, a virtual storage node, or other type of storage resource that is supported/provided by storage space of one or more physical/hardware disks (e.g., storage resources provided by the distributed storage system 152 of FIG. 1). Examples of prediction time may be one or more timeframes or time ranges/periods, starting from the present to a finite time in the future, in which the status of an entity (e.g., a logical storage unit, one or more hardware disks, etc.) is predicted.

In FIG. 2, an internal network 200 (e.g., a customer environment) and an external network 202 (e.g., a public cloud environment) are shown. The external network 202 includes an analytics portal 204 deployed at a cloud (e.g., a public cloud or a private cloud), for purposes of simplicity of explanation and as examples hereinafter in some of the disclosed embodiments—the analytics portal 204 may be deployed in various types of external network arrangements that include one or more computing devices and which may not necessarily be arranged as a cloud environment.

The analytics portal 204 of various embodiments provides a service that performs analytics using the information/data provided from the internal network 202, including performing analytics using machine learning techniques. Such analytics may be performed, for example, in connection with intelligent capacity planning as will be described in further detail below.

The internal network 200 includes a plurality of hosts 210 (e.g., the host-A 110A . . . host-N 110N shown in FIG. 1) that are configured to provide storage resources for a hyperconverged storage 212 (e.g., the distributed storage system 152 shown in FIG. 1). The operation of the hosts 210 is managed by one or more management servers 214 (e.g., the management server 142 shown in FIG. 1).

In operation, the agent 140 (also shown in FIG. 1) at each host 210 collects (at 216) customer environment information (e.g., performance metrics, statistics, etc., all of which are labeled as storage information in FIG. 2) from the hyperconverged storage 212. As an example, the storage information that is collected and/or compiled by each agent 140 may include self-monitoring, analysis, and reporting technology (SMART) information that pertains to the hyperconverged storage 212, including information that provides indicators of reliability for use in predicting hardware failures, reduced capacity, reduced availability, etc.

An orchestrator 206 (e.g., a service, agent, daemon, or other component) of the management server 214 then collects (at 218) this storage information (e.g., SMART information) from each of the managed hosts 210, and sends (at 220) the collected information to the analytics portal 204 deployed at the external network 202 for machine learning model training.

According to various embodiments, after the machine learning model is trained by the analytics portal 204, the trained machine learning model and prediction(s) of disk failures is obtained (at 222) from the analytics portal 204 by the management server 214. In some embodiments, the management server 214 may perform the prediction(s) of disk failures using the trained machine learning model obtained from the analytics portal 204, alternatively or additionally to receiving such prediction(s) from the analytics portal 204.

As an example, the orchestrator 206 and/or some other component of the management server 214 may be able to obtain a prediction (e.g., a prediction result outputted from a machine-learning model) of the disk failures within a given time period (e.g., a prediction of hardware disk failures that may occur in the next coming week or other prediction time) from the analytics portal 204. The management server 214 is then configured to combine the disk failure prediction result(s) with information about the hyperconverged storage 212 to obtain a failure prediction for a logical storage unit that is comprised of storage space from one or more hardware disks. The management server 214 is also able to perform what-if operations in connection with using failure predictions to predict operational impacts of storage configurations/reconfigurations before such configurations/reconfigurations are actually performed.

Examples of methods for model training, for predicting logical storage unit failures, and for performing what-if predictions are described next below.

Training a Machine Learning Model for Hardware Disk Failure Prediction

Various embodiments disclosed herein perform capacity planning based on failure predictions generated by trained machine learning models. The training and output of the machine learning model(s) can be based at least in part on the storage information 216 of FIG. 2 (e.g., SMART information) that is used to perform computations/predictions of physical/hardware disk failures for storage resources in the hyperconverged storage 212.

With the disk hardware failure prediction approach of various embodiments, a prediction may be made as to whether a set of given disks will all fail in a given time frame. Such an approach differs from other techniques that are based on a failure prediction for a single disk, such as techniques based on traditional deep learning models like recurrent neural network (RNN) or long short-term memory (LSTM) networks. However, these models/techniques rely on previous hidden states and disks' SMART information given in a time series order, which may cause unsatisfactory training efficiency. Also, long dependency issues in RNN/LSTM models may cause prediction performance degradation over time.

Therefore, rather than a traditional deep learning model, various embodiments use a transformer-based, time-series prediction model, which exhibits higher training efficiency and better performance, and which uses parallel computing and a self-attention mechanism. Specifically, transformer is an encoder-decoder model that may be completely based on the self-attention mechanism and that may omit the repetition and convolution of a traditional deep learning model. A multi-head, transformer-based model according to various embodiments predicts a set of disk failures in given time period.

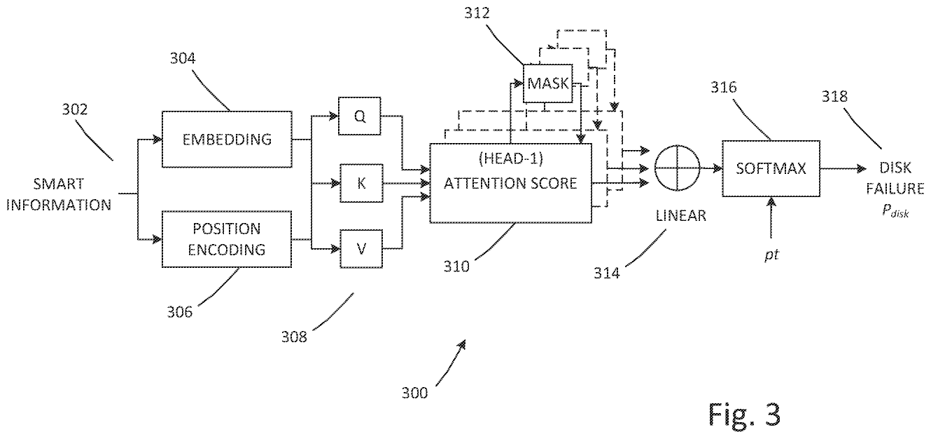

FIG. 3 is a schematic diagram showing an example training workflow 300 for hardware disk failure prediction. The workflow 300 may be performed, for example, by the analytics portal 204 at the external network 202 of FIG. 2, using a machine learning model based on the multi-head, transformer-based approach with self-attention.

As shown in FIG. 3, the workflow 300 is based on the training on the SMART information of disks. During disk use, disk statistics (e.g., disk metrics) at each point in time represent a different effect on the disk performance, and eventually leads to disk failure. For prediction of such failures, the self-attention feature of the transformer-based model can calculate an attention score, which evaluates how the status of these disk affect each other, and can then calculate a prediction result.

Given a disk status sequence X={x₁, x₂, . . . , x_{T}} and a prediction time pt, the output of the workflow 300 is the probability P_{disk} of a single disk failure in prediction time pt (e.g., time 0 to time T). The per disk status xₜ contains a disk's SMART information (which provides disk state changes over time) at the time slot t, including seek time performance, throughput performance, etc. The transformer-based model based on the workflow 300 receives the input sequence x, and generates the probability P_{disk} of a single disk's failure in the prediction time pt.

In detail, the model receives the disk status sequence X (a time series) as input (e.g., SMART information input) at 302, and calculates the embeddings (at 304). The position encodings are calculated at 306 according to sine and cosine functions, and explicitly indicate the position of xt. For example, each xₜ of X contains the disk's statistics (including many attributes such as seek time performance, etc.) at time t, and the time positional information is the position encoding. Accordingly, an example of the X matrix may be as follows:

$$X = \{ {x}_{1} , {x}_{2} , … , {x}_{T} \} = \begin{matrix}seek time performance data ⟶ \\ ∶ \\ throughout performance data ⟶\end{matrix} ( \begin{matrix}{x}_{1 , 1} & … & {x}_{1 , T} \\ ⋮ & ⋱ & ⋮ \\ {x}_{K , 1} & … & {x}_{K , T}\end{matrix} )$$

The self-attention layer receives the embeddings and position encodings and defines (at 308) three parameters (vectors) related to the input: query (Q=W_{Q}X), key (K=W_{K}X), and value (V=W_{V}X), where W terms denote weight matrices. These vectors Q, K, and V are created by multiplying the embedding by three weight matrices (e.g., by multiplying x₁ by the W_{Q} weight matrix to produce q₁) that were trained during the training process. These three vectors Q, K, and V are used for calculating a self-attention score S. In the self-attention layer, the self-attention score S is calculated (at 310) through the following example equation:

$${S}_{i} ( Q , K , V ) = Softmax ( \frac{Q * {K}^{⊤} + Mask}{\sqrt{{d}_{x}}} ) * V$$

In the foregoing equation, the attention score S means the influence weight of the disk status (including disk capacity, health status, etc.) at each time slot in the history. A Mask matrix is added (at 312) to exclude the influence of padding values (which is usually set to 0) in the attention score calculation. For example, the Mask matrix can used for an offset to fine-tune the attention score and prediction, and may be trained.

In the transformer model, self-attention enables the model to look at other time positions in the input sequence for clues that can help lead to a better knowledge for the disk stats change. Multi-head self-attention is used in various embodiments of the model since it is beneficial to allow the model to focus on disk SMART information from different aspects and time series positions.

Multi-heads provide multiple representation sub-spaces for the attention score calculation for disk SMART information/statistics. With multi-head attention, there are multiple parallel sets of query/key/value weight matrices. Each of these sets is randomly initialized. Then, after training, each set is used to project the input embeddings (or vectors from lower encoders/decoders) into a different representation subspace.

Weights of each attention head (e.g., shown as head-1 etc. in FIG. 3) may be trained in parallel, and the attention scores {s₁, . . . , sₙ} (n=number o f heads) may be concatenated and merged into a final attention score through a linear layer (at 314). A Softmax layer (at 316) accepts the self-attention score sequence from the decoder layer for linear normalization, and for the prediction time pt that is set, predicts (at 318) the probability P_{disk} of a single disk failure within the prediction time pt. The probability P_{disk} or probability score (prediction result) may be (0 to 1) for instance. The foregoing operations may be represented by the following example equations:

S_{n-heads}=Concat(s₁, . . . , sₙ)*Wₗᵢₙₑₐᵣ

P_{disk}=Softmax(S_{n-heads},pt)

P_{disk}∈[0,1]

In the example equations above, S_{n-heads} denotes the final attention score of n heads, and Wₗᵢₙₑₐᵣ denotes the weight matrix of the linear layer.

Since a logical storage unit may be usually comprised of storage space provided by multiple disks in the hyperconverged storage 212 or other distributed storage environment, various embodiments provide capability to predict the probability P of some number of disks N failing in a disk set in a given time period, based at least on the foregoing techniques to calculate a prediction for a single disk failure. A calculation of the prediction of the probability P of failure for N disks in a disk set or group (e.g., a plurality of physical/hardware disks) can be described with an example Algorithm 1 below:

Algorithm 1: Hardware Storage Group Failure Prediction

Input: P_{disk-1}, ... , P_{disk-M}, Prediction Time (PT), Number of Failures (NF)
Output: Probability P of NF disk failures happen in a disk set in prediction
time

| | |
|---|---|
| 1. | Get all combination cases N of any NF disks selected in the set |
| 2. | For each combination case i in N |
| 3. | Return P_{case-i} = Πₖ^{NF}(P_{disk-k}) * Πⱼ^{M-NF}(1 − P_{disk-j}), |
| | (where k ∈ disks will fail, j ∈ disks will not fail) |
| 4. | Return P = Σᵢ^{N} P_{case-i} |

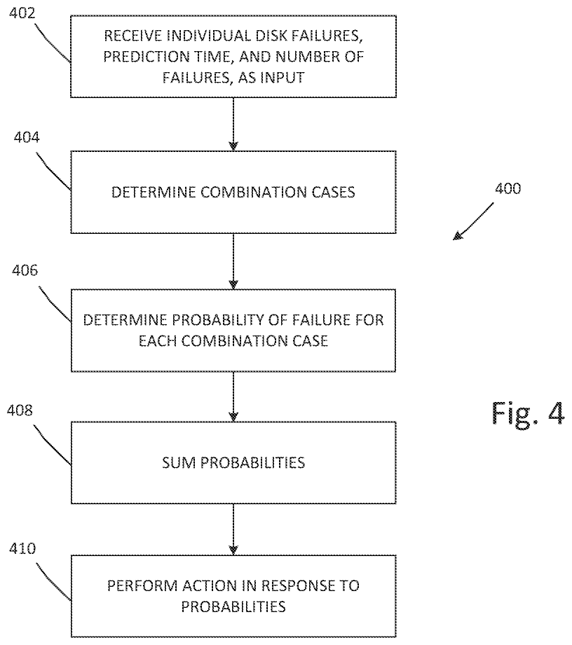

Algorithm 1 may be explained by making reference to FIG. 4, which is a flowchart of an example method 400 to predict the failure of a disk set (disk group) in the virtualized computing environment 100 of FIGS. 1 and 2. For example, at least some of the disks in the set may have been involved in the same procurement cycle, and so may have similar ages, usage over time, etc., and as such, may have a probability of failing at about the same time.

The example method 400 (and Algorithm 1) may be performed by the analytics portal 204 and/or by management server 214 of FIG. 2, and may include one or more operations, functions, or actions illustrated by one or more blocks, such as blocks 402 to 410. The various blocks of the method 400 and/or of any other process(es) described herein may be combined into fewer blocks, divided into additional blocks, supplemented with further blocks, and/or eliminated based upon the desired implementation. In one embodiment, the operations of the method 400 and/or of any other process(es) described herein may be performed in a pipelined sequential manner. In other embodiments, some operations may be performed out-of-order, in parallel, etc.

The method 400 may begin at a block 402 (“RECEIVE INDIVIDUAL DISK FAILURES, PREDICTION TIME, AND NUMBER OF FAILURES, AS INPUT”), in which a plurality of inputs are received for Algorithm 1. These inputs may include: the predicted failure P_{disk-1}, . . . , P_{disk-M} (e.g., a plurality of first predictions) of each respective individual disk in the disk set, as individually calculated using the workflow 300 of FIG. 3; the prediction time (PT); and a number of failures (NF) that may occur in the disk set. Receiving inputs at the block 402 and/or other block(s) may involve receiving values entered by a user, extracting the values from a database or other source(s), computing the values, etc.

The block 402 may be followed by a block 404 (“DETERMINE COMBINATION CASES”) that corresponds to line 1 of Algorithm 1. At the block 404, the method 400 gets all combination cases N of any NF disks selected in the disk set. As an example, a disk set may be comprised of three disks (e.g., disk1, disk2, and disk3), and the combination cases of possible failed disks may be independent failures of just disk1, just disk2, just disk3, disk1 and disk2, disk1 and disk3, disk2 and disk3, and all three disk1, disk2, and disk3.

The block 404 may be followed by a block 406 (“DETERMINE PROBABILITY OF FAILURE FOR EACH COMBINATION CASE”) that corresponds to lines 2 and 3 of Algorithm 1. At the block 406, the probability of failure for each combination case is determined based on (e.g., as a product of) the probabilities of individual disk failures and probabilities of individual disk non-failures. These individual and independent probabilities were previously obtained using the workflow 300 of FIG. 3, and are used in the block 406 for the computation of the probability of failure for each combination case.

The block 406 may be followed by a block 408 (“SUM PROBABILITIES”) that corresponds to line 4 of Algorithm 1. At the block 408, the probability P (e.g., a second prediction) of some disk failures in the disk set is obtained, such as by summing the failure probabilities of each combination case that were computed at the block 406.

The block 408 may be followed by a block 410 (“PERFORM ACTION IN RESPONSE TO PROBABILITIES”), in which one or more of the probabilities of failure of disks in a disk set calculated at the block 408 are used to perform a subsequent action. For example, the subsequent actions can include at least one of: providing an alert to a system administrator (and/or other user or entity) regarding the probabilities, so as to enable the entity to further evaluate the probability information; initiating a procurement cycle for new disks, etc.; providing recommendations for maintenance windows and hardware replacements; using the calculated probabilities for computing other predictions (described next below); and/or other actions related to capacity planning.

Prediction of Failure of a Logical Storage Unit

The foregoing description involved embodiments of methods to predict the possibility of a set of physical disk failures in the given time period (e.g., within the prediction time). The above-described machine learning model and predictions may be leveraged to calculate a prediction (e.g., a third prediction) for a failure of a logical storage unit in the hyperconverged storage 212, based on a configuration state of the logical storage unit.

For a logical storage unit, there may be two scenarios involving the underlying topology in terms of prediction: topology unchanged and topology changed. For example, a logical storage unit may be configured according to RAID 1, with a failure to tolerate (FTT)=1 (e.g., 2 copies of a piece of data are replicated on respective two disks). In this configuration, a single disk failure will not cause lost data since the data is replicated/stored on another disk.

If there is no hardware failure or user reconfiguration, then the underlying topology for the storage object stays unchanged. However, if one disk has failed, there is a replica placed/stored in a separate (another) disk during the resynch process. This is one example case where the underlying topology has changed. User-initiated changes to the configuration of the storage object may also trigger an underlying topology change (e.g., a change in the storage object from a RAID 1 configuration to a RAID 5 or RAID 6 configuration).

Based on the two scenarios of topology unchanged and topology changed, the prediction of a failure for a logical storage unit (e.g., a storage object in the hyperconverged storage 212) can be described with an example Algorithm 2 below:

Algorithm 2: Logical Storage Unit Failure Prediction

Input: Logical Storage Unit Identifier (LSUI), Prediction Time (PT)
Output: Rate of Logical Storage Unit Status

| | |
|---|---|
| 5. | If LogicalStorageUnitInReconfig(LSUI) Then |
| 6. | Return LogicalStorageUnitFailurePredictionForReconfig(LSUI) |
| 7. | Else LogicalStorageUnitInResync(LSUI) Then |
| 8. | Return LogicalStorageUnitFailurePredictionForResync(LSUI) |
| 9. | Endlf |
| 10. | Disks <− GetTopologyDisksForStorageUnit(LSUI) |
| 11. | LeastQuorum <− GetLeastQuorumForStorageUnit(LSUI) |
| 12. | failureRate <− CalculateDisksFailure(Disks, PT, LeastQuorum) |
| 13. | reducedAvailabilityRate <− CalculateDisksFailure(Disks, PT, 1) |
| 14. | Return failureRate, reducedAvailabilityRate |

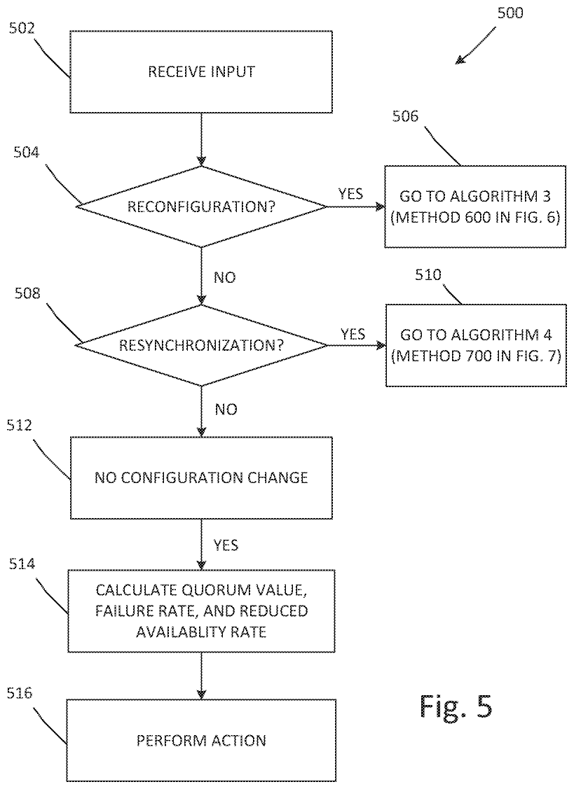

Algorithm 2 may be explained by making reference to FIG. 5, which is a flowchart of an example method 500 to predict the failure (and also reduced availability) of a logical storage unit in the virtualized computing environment 100 of FIGS. 1 and 2. In some embodiments, reduced availability may involve a logical storage unit maintaining some operability, albeit with intermittent availability, latency, etc., while a failure may be considered in some contexts to be an extreme case of reduced availability (e.g., no availability at all). The operations in the method 500 (and Algorithm 2) may be performed, for example, by the management server 214 in FIG. 2 in response to receiving trained model(s) and/or failure predictions for individual disks or disk sets from the analytics portal 204 located at a cloud or at other type of external network 202.

In Algorithm 2, a prediction of a failure rate of a logical storage unit is computed for three example cases: the logical storage unit is in a reconfiguration state (lines 5 and 6 of Algorithm 2); the logical storage unit is in resync state (lines 7 and 8 of Algorithm 2); and the logical storage unit's topology is unchanged (lines 10-14 of Algorithm 2). With reference to FIG. 5, the method 500 may begin at a block 502 (“RECEIVE INPUT”), in which a plurality of inputs are received for Algorithm 2. These inputs may include: a logical storage unit identifier (LSUI) that identifies the specific logical storage unit for which failure prediction is being performed and a prediction time (PT). In some embodiments, the probability P that was computed using Algorithm 1 above may be amongst the inputs received at the block 502 of the method 500. Receiving inputs at the block 502 and/or other block(s) may involve receiving values entered by a user, extracting the values from a database or other source(s), computing the values, etc.

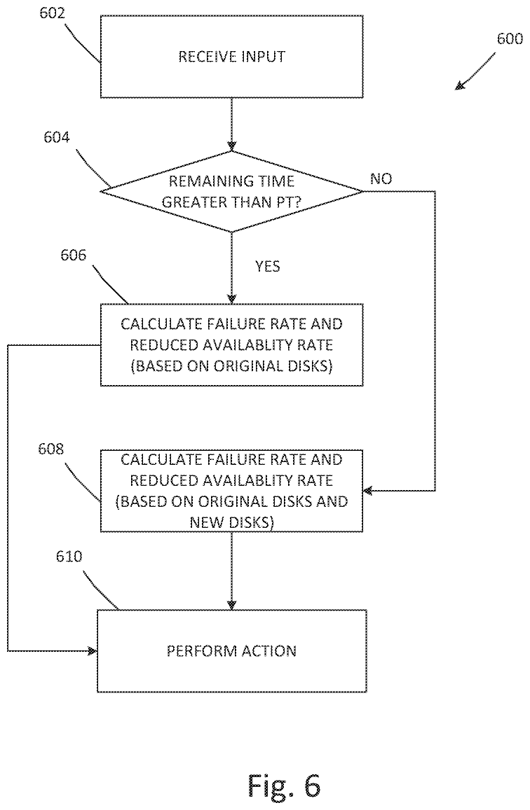

Next at a block 504 (“RECONFIGURATION?”), the method 500 determines whether a reconfiguration state (other than a resynch state) exists. If such a reconfiguration state exists (“YES” at the block 504), then the method 500 proceeds to a block 506 to execute an Algorithm 3 (a method 600 in FIG. 6) to compute a failure prediction for the logical storage unit in a reconfiguration state (e.g., details for computing the value of the prediction LogicalStorageUnitFailurePredictionForReconfig shown in line 6 of Algorithm 2 above).

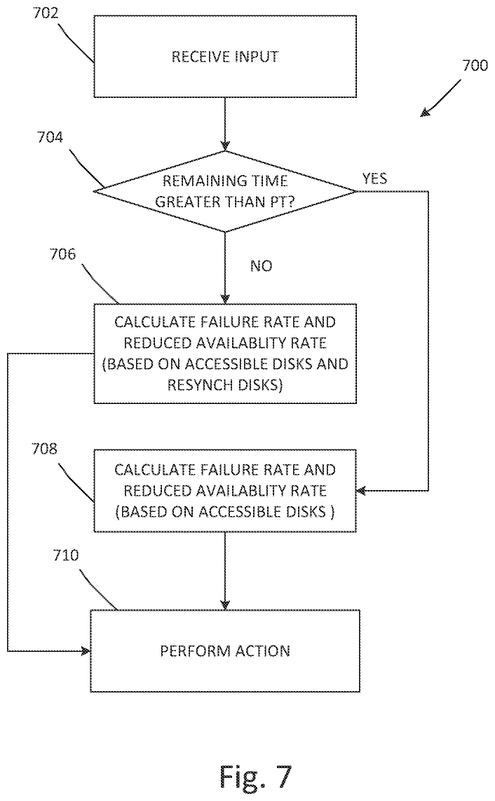

Next at a block 508 (“RESYNCH?”), the method 500 determines if there is a resynch state. If the resynch state exists (“YES” at the block 508), then the method 500 proceeds to a block 510 to execute an Algorithm 4 (method 700 in FIG. 7) to compute a failure prediction for the logical storage unit in a resynch state (e.g., details for computing the value of the prediction LogicalStorageUnitFailurePredictionForResync shown in line 8 of Algorithm 2 above).

If there is no reconfiguration/resynch (“NO” at the block 508), then the method proceeds to a block 512 (“NO CONFIGURATION CHANGE”). At the block 512 (corresponding to line 10 of Algorithm 2), the method 500 first obtains information about all of the disks that the replicas are populated on, such as topology information, LSUIs, etc.

The block 512 may be followed by a block 514 (“CALCULATE QUORUM VALUE, FAILURE RATE, AND REDUCED AVAILABLITY RATE”), wherein the method 500 calculates a quorum value (e.g., a majority value), specifically a least quorum value for the logical storage unit (line 11 of Algorithm 2). For instance, for a RAID 1 configuration for a storage object, there are n replicas, thereby requiring at ieast

$$⌈ \frac{n}{2} ⌉$$

replicas for an example quorum or some other mathematical representation of a majority. Quorum-based consensus algorithms are often used to provide better consistency in distributed storage systems. For example, a distributed storage system may include a cluster of storage nodes such that the same piece of data is replicated in each storage node of the cluster. When the data is modified in one of the storage nodes, the modifications should be replicated in the other storage nodes so as to provide consistency in the data throughout the cluster. If a quorum-based consensus algorithm is implemented in the distributed storage system, the modification of the data in one of the storage nodes will first require a quorum of the other storage nodes to be available to implement the same modification and to provide permission to perform the modification.

When a number of storage nodes is below the least quorum requirement/value, then the modification of the data (and also writes) is unable to be performed, thereby effectively rendering the logical storage unit as unavailable/failed. Therefore, a least quorum value may represent a threshold minimum number of disks that need to be available/operational in order to enable a logical storage unit to function, and anything less than the least quorum value (e.g., a lost quorum corresponding to the least quorum value being unmet) results in unavailability of the logical storage unit. In comparison, losing/reducing one or more disks due to failure, while still maintaining a number of available/operational disks above the least quorum value, permits the logical storage unit to continue to function, albeit at a possibly reduced availability.

Using the model trained in Algorithm 1 (and its corresponding failure prediction P for a number of disks in the disk set), the method 500 is able to predict the rate of the disk failure for the LeastQuorum count at the block 514 (e.g., the failureRate value in line 13 of Algorithm 2). This failureRate value provides the prediction of the possibility of the logical storage unit failing. With respect to the reducedAvailabilityRate value in line 13 of Algorithm 2, the possibility of a single disk failure, for example, results in a reduced availability possibility of that logical storage unit.

The failureRate value and/or the reducedAvailabilityRate value is outputted by the method 500 at the block 514 (corresponding to line 14 of Algorithm 2) as predictions. At a next block 516 (“PERFORM ACTION”), various actions may be performed in response to these predictions, such as those described above with respect to block 410 in FIG. 4.

FIG. 6 shows an example of the method 600 to predict the failure (and also reduced availability) of a logical storage unit in a reconfiguration state in the virtualized computing environment 100 of FIGS. 1 and 2. The method 600 corresponds to the block 506 in FIG. 5, and may be described with reference to an example Algorithm 3 below:

Algorithm 3: Logical Storage Unit Failure
Prediction for Reconfiguration State

Input: Logical Storage Unit Identifier (LSUI), Prediction Time (PT)
Output: Possibilities of Logical Storage Unit Status

| | |
|---|---|
| 1. | remainTime <− RemainDataToSync / SyncSpeed |
| 2. | originalDisks <− GetOriginalTopologyDisksForStorageUnit(LSUI) |
| 3. | newDisks <− GetConfiguredTopologyDisksForStorageUnit(LSUI) |
| 4. | originalLeastQuorum <− GetOriginalQuorumForStorageUnit(LSUI) |
| 5. | newLeastQuorum <− GetConfiguredQuorumForStorageUnit(LSUI) |
| 6. | If remainTime > PT Then |
| 7. | failurePossibility <− CalculateDisksFailure(originalDisks, |
| | PT, originalLeastQuorum) |
| 8. | reducedAvailabilityPossibility <− |
| | CalculateDisksFailure(originalDisks, PT, 1) |
| 9. | Else |
| 10. | failurePossibility <− 1 − (1 − CalculateDisksFailure(originalDisks, |
| | remainTime, originalLeastQuorum)) * (1 − |
| | CalculateDisksFailure(newDisks, PT, newLeastQuorum)) |
| 11. | reducedAvailabilityPossibility <− (1 − |
| | CalculateDisksFailure(originalDisks, remainTime, |
| | originalLeastQuorum)) * CalculateDisksFailure(newDisks, PT, 1) |
| 12. | EndIf |
| 13. | Return failurePossibility, reducedAvailabilityPossiblity |

Beginning at a block 602 (“RECEIVE INPUT”), the method 600 receives a plurality of inputs for Algorithm 3. The plurality of inputs may include one or more of a LSUI of the logical storage unit, prediction time PT, topology information associated with the original disks and the new disks, least quorum values for the previous and new configurations, time value(s) for performing the reconfiguration, amount of data involved in the reconfiguration, reconfiguration speed, etc. Receiving inputs at the block 602 (corresponding to lines 1-5 of Algorithm 3) and/or other block(s) may involve receiving values entered by a user, extracting the values from a database or other source(s), computing the values, etc.

A prediction of a rate of total failure and reduced availability may be a combination of both a previous replica disks failure rate, and a destination replica disks failure rate. Such prediction considers an amount of time (remaining time) to finish the reconfiguration for the logical storage unit.

At a block 604 (“REMAINING TIME GREATER THAN PT?”), the method 600 determines whether reconfiguration has been completed. If, at the prediction time PT, the reconfiguration is already done (“NO” at the block 604), then the predicted failure rate of the reconfigured logical storage unit is determined/computed based on a predicted failure rate of the previous configuration of the logical storage unit having lost quorum (which is computed according to Algorithm 2 previously described above), combined with a predicted failure rate of the newly configured logical storage unit having lost quorum. This prediction computation of the failure rate of the logical storage unit (with reconfiguration done) is performed at a block 608 (“CALCULATE FAILURE RATE AND REDUCED AVAILABILITY RATE (BASED ON ORIGINAL DISKS AND NEW DISKS)”) of method 600, and corresponds to line 10 of Algorithm 3.

However, if back at the block 604, the remaining time is greater than the prediction time (“YES” at the block 604), in which the reconfiguration is not yet done, then the predicted failure rate of the logical storage unit is determined/computed as the failure rate of the previous configuration of the logical storage unit having lost quorum. The computation of this prediction may be performed at a block 606 (“CALCULATE FAILURE RATE AND REDUCED AVAILABILITY (BASED ON ORIGINAL DISKS)”) of the method 600 (corresponding to line 7 of Algorithm 3), which also corresponds to the computations performed in accordance with the previously described Algorithm 2.

The foregoing predictions of failure rates at the blocks 606 and 608 may be computed based on the following example equation:

$$failure Rate = \{ \begin{matrix}1 - ( 1 - Previous Unit Lost Quorum Rate ) * ( 1 - New Unit Lost Quorum Rate ) \\ if reconfig done \\ Previous Unit Lost Quorum Rate if reconfig is in progress\end{matrix}$$

Analogously to the foregoing, predictions of the rate of the logical storage unit having reduced availability is based on the loss of at least one disk from the quorum. Such predictions of a reduced availability rate may be computed (at blocks 606 and 608, corresponding respectively to lines 8 and 11 of Algorithm 3, based on the following example equation:

$$ra Rate = \{ \begin{matrix}1 - ( 1 - P r e vious Unit Lost One Quorum Rate ) * ( 1 - New Unit Lost One Quorum Rate ) \\ if reconfig done \\ P r e vious Unit Lost One Quorum Rate if reconfig is in progress\end{matrix}$$

After the predictions are generated at the block 606 and/or the block 608, the method 600 proceeds to a block 610 (“PERFORM ACTION”), wherein some capacity planning related actions may be performed in response to the prediction(s). Example actions related to capacity planning that may be performed at the block 610 are described previously above for blocks 410 and 516 in respective FIGS. 4 and 5.

FIG. 7 shows an example of the method 700 to predict the failure (and also reduced availability) of a logical storage unit in a resynchronization (resynch) state in the virtualized computing environment 100 of FIGS. 1 and 2. The resynch state may be considered to be an example case (e.g., a subset) of a reconfiguration state. The method 700 corresponds to the block 510 in FIG. 5, and may be described with reference to an example Algorithm 4 below:

Algorithm 4: Logical Storage Unit
Failure Prediction for Resync State

Input: Logical Storage Unit Identifier (LSUI), Prediction Time (PT)
Output: Possibilities of Logical Storage Unit Status

| | |
|---|---|
| 1. | remainTime <− RemainData ToSync / SyncSpeed |
| 2. | accessibleDisks <− GetAccessibleDisksReplicaForStorageUnit(LSUI) |
| 3. | resyncDestDisks <− |
| | GetResyncDestinationDisksForStorageUnit(LSUI) |
| 4. | leastQuorum <− GetQuorumForStorageUnit(LSUI) |
| 5. | If remainTime > PT Then |
| 6. | failurePossibility <− CalculateDisksFailure(accessibleDisks, PT, |
| | count(accessibleDisks) - leastQuorum) |
| 7. | downgradePossibility <− 100% |
| 8. | Else |
| 9. | failurePossibility <− 1 − (1 − |
| | CalculateDisksFailure(accessibleDisks, remainTime, |
| | count(accessibleDisks) − leastQuorum)) * (1 − |
| | CalculateDisksFailure(accessibleDisks + resyncDestDisks, PT, |
| | leastQuorum)) |
| 10. | downgradePossibility <− (1 − |
| | CalculateDisksFailure(accessibleDisks, remain Time, |
| | count(accessibleDisks) − leastQuorum)) * |
| | CalculateDisksFailure(accessibleDisks + resyncDestDisks, PT, 1) |
| 11. | EndIf |
| 12. | Return failurePossibility, downgradePossiblity |

Beginning at a block 702 (“RECEIVE INPUT”), the method 700 receives a plurality of inputs for Algorithm 4. The plurality of inputs may include one or more of a LSUI of the logical storage unit, prediction time PT, topology information associated with the original/accessible disks and the new disks, least quorum values for the previous and new configurations, time value(s) for performing the resynch, speed of resynch, amount of data to complete the resynch, etc. Receiving inputs at the block 702 (corresponding to lines 1-4 of Algorithm 4) and/or other block(s) may involve receiving values entered by a user, extracting the values from a database or other source(s), computing the values, etc.

During the resync state, the logical storage unit itself is in a reduced availability status. The logical storage unit will synchronize data on separate disks so as to resume the number of required replicas in accordance with the storage policy. For example, if a logical storage unit has a RAID 1 configuration with a FTT=2, then the configuration design may dictate that 5 replicas/components be provided. Thus, if the logical storage unit has lost two replicas/components, the logical storage unit could still operate, but with a reduced availability status. The resync process will generate the two lost replicas/components on respective two new disks so as to have the logical storage unit restored back to the normal status of five replicas.

With reference back to FIG. 7, the block 702 may be followed by a block 704 (“REMAINING TIME GREATER THAN PT?”), wherein the specific computation/determination of the prediction of the failure rate or reduced availability rate is dependent on whether the resynch process is done relative to the prediction time PT. The predictions for the rate of logical storage unit failure and reduced availability for the resynched logical storage unit, according to various embodiments, is a combination of the rate of failures of remaining replicas and the rate of failures of newly synched replicas.

If the resynch is still in progress (“YES” at the block 704), then the method 700 proceeds to a block 708 (“CALCULATE FAILURE RATE AND REDUCED AVAILABILITY (BASED ON ACCESSIBLE DISKS”). At this block 708, the prediction of a possible failure of the logical storage unit is computed based on the number of accessible disks that exist previous to the completion of the resynch process and on a least quorum value for these accessible disks. Such computation is shown at line 6 of Algorithm 4 above, and may be performed using the previously described Algorithms 1 and/or 2 to compute a prediction of a failure of number of disks based on a least quorum value for the disks. Also at the block 708, the prediction of the reduced availability rate is a downgrade possibility of 100% (shown at line 7 of Algorithm 4).

If, back at the block 704, the resynch process is determined to be completed (“NO” at the block 704), then the method 700 proceeds to a block 706 (“CALCULATE FAILURE RATE AND REDUCED AVAILABILITY (BASED ON ACCESSIBLE DISKS AND RESYNCH DISKS)”). At the block 706, the failure rate (failure possibility) and reduced availability rate (downgrade possibility) may be computed based at least on the count of accessible disks, count of resynch destination disks, least quorum value, and so forth, such as shown at lines 9 and 10 of Algorithm 4.

The following example equations may be used in the computation of predicted failure rate and predicted reduced availability rate, dependent on whether the resynch process has been completed:

$$failure Rate = \{ \begin{matrix}1 - ( 1 - P r e vious Unit Lost Quorum Rate ) * ( 1 - New Unit Lost Quorum Rate ) \\ if resync done \\ Previous Unit Lost Quorum Rate if resync is in progress\end{matrix}$$

$$ra Rate = \{ \begin{matrix}1 - ( 1 - P r e vious Unit Lost One Quorum Rate ) * ( 1 - New Unit Lost One Quorum Rate ) \\ if resync done \\ P r e vious Unit Lost One Quorum Rate if resync is in progress\end{matrix}$$

After the predictions are generated at the block 706 and/or the block 708, the method 700 proceeds to a block 710 (“PERFORM ACTION”), wherein some capacity planning related actions may be performed in response to the prediction(s). Example actions related to capacity planning that may be performed at the block 710 are described previously above for blocks 410 and 516 in respective FIGS. 4 and 5

Prediction of Failure Based on a What-If Operation

Conventional techniques for predicting the impact of what-if operations do not consider the disk failure rate in an upcoming timeframe. Such conventional techniques only calculate predictions based on a current configuration. For example, if a host decommissioning operation will decommission the component for the logical storage unit in a manner that will cause a quorum to be insufficient, the prediction result will report that the decommissioning operation will cause inaccessibility of the logical storage unit. Otherwise, if the logical storage unit will still hold a sufficient quorum, and has just lost one component, the prediction result will report that the decommissioning operation will cause reduced availability for the storage unit. However, if after the performing the decommissioning, a disk failure soon causes another component to become lost/unavailable, thereby causing the logical storage unit to lose the quorum, the previous/conventional what-if prediction technique is unable to predict such a result. This inability leads to data lost for users.

Therefore, a solution for disk predictions is provided by various embodiments for a what-if operation, in a manner that addresses the above and/or other drawbacks of conventional what-if prediction techniques. With an example of such a solution and given a what-if operation, a prediction can be provided for a failure rate of the logical storage unit and a reduced availability rate of the logical storage unit. Embodiments are described herein in the context of a what-if host decommission operation as an example, and embodiments can be extended to predictions for other types of what-if operations.

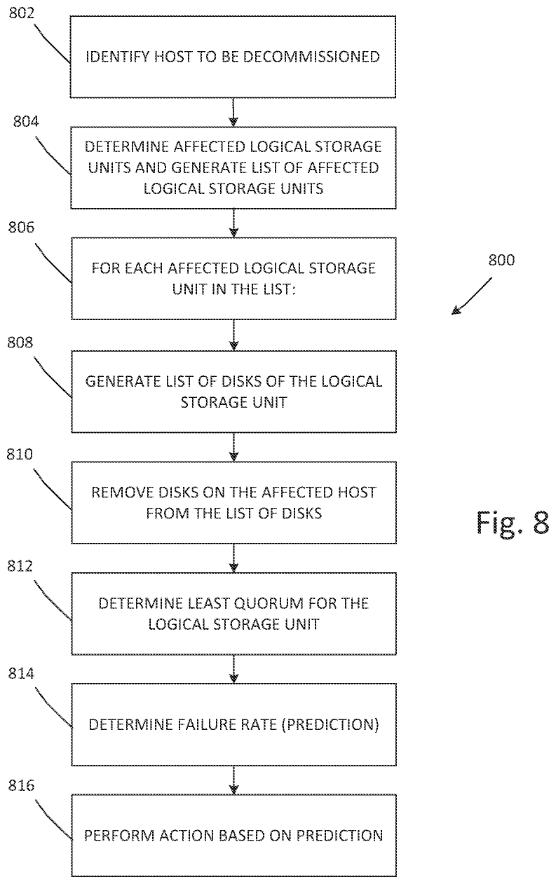

FIG. 8 is a flowchart showing an example of a method 800 to predict the failure of a logical storage unit based on what-if operations in the virtualized computing environment 100 of FIGS. 1 and 2. The method 800 may be performed by the management server 214, and may be described with reference to the example Algorithm 5 below:

Algorithm 5: What-If Operations Prediction
(e.g., host decommission)

Input: Host to decom (HostToDecom)
Output: Failure rate of the affected Logical Storage Units

| | |
|---|---|
| 1. | StorageUnitList <− |
| | GetAffectedStorageUnitList(HostTopDecom) |
| 2. | For SU in StorageUnitList; Do |
| 3. | disksList <− GetPopulatedDisksForStorageUnit(SU) |
| 4. | disksList <− RemoveDisksOnHostToDecom(diskList, |
| | HostToDecom) |
| 5. | leastQuorum <− GetQuorumForStorageUnit(SU) |
| 6. | failureRate <− CalculateDisksFailure(disksList, leastQuorum − 1) |
| 7. | Done |
| 8. | Return {SU: failureRate} |

In general, a what-if operation may be considered to be an operation that attempts to determine one or more impacts of an actual operation, without actually performing the operation in a live computing environment. For example, a what-if host decommissioning operation attempts to determine the impact(s) of deactivating or removing a host from the virtual computing environment 100 of FIG. 1, without actually performing the deactivation/removal in the live environment. Such potential impacts of a what-if operation in the form of a host decommissioning operation may include, for instance, deactivation of the hardware disks on the affected host, shut down of the VMs running on the affected host, etc., including impacts that may have a ripple effect towards other components in the virtualized computing environment 100.

Such impacts of the what-if operation may be performed in a number of ways. For example, emulations or simulations may be performed in a test environment to determine the impact of a what-if operation. In other examples, some of the impacts may be more readily determined, without involving emulations or simulations in a test environment. For example, if a host is decommissioned, it can be readily known or recognized that the VMs and hardware disks on that hosts are no longer available for use or are no longer running.

Embodiments of the techniques disclosed herein provide the capability to provide failure predictions (including reduced availability predictions) based on a result of a what-if operation. For example, if the what-if operation is a what-if host decommissioning operation, the what-if host decommissioning operation hypothetically deactivates/removes a host from the virtualized computing environment, thereby providing a result in which the hardware disks on the decommissioned host become unavailable. The prediction techniques disclosed herein then provide the capability to predict the failure or reduced availability of the hardware disks that would remain in the distributed storage, after the hardware disks on the decommissioned host have been hypothetically removed from the distributed storage.

Beginning at a block 802 (“IDENTIFY HOST TO BE DECOMMISSIONED”), the method 800 receives at least one input for Algorithm 5, including identification of a particular what-if operation that is to be evaluated for particular component(s) in the virtualized computing environment 100. For example, if the what-if operation is a host decommissioning operation (e.g., to decommission host-A 110A), then an input received at the block 802 may be an identification of which host is to be decommissioned. The plurality of inputs may include one or more other types of information such as LSUIs of logical storage units, prediction time PT, topology information, least quorum values, time value(s), etc., all of which may vary from one implementation to another dependent on the type of what-if operation is being evaluated, on the affected components, etc. Receiving inputs at the block 802 and/or other block(s) may involve receiving values entered by a user, extracting the values from a database or other source(s), computing the values, etc.

The block 802 may be followed by a block 804 (“DETERMINE AFFECTED LOGICAL STORAGE UNITS AND GENERATE LIST OF AFFECTED LOGICAL STORAGE UNITS”), wherein the method 800 determines all of the logical storage units that will be affected by (hypothetically) decommissioning the host, such as shown at line 1 of Algorithm 5. If there are at least one component is populated/supported on the host, then the logical storage unit is considered to be affected at the block 804. For example, the hardware disks on host-A 110A may be providing storage spaces for logical storage units AA, BB, and CC (and with hardware disks on other hosts also providing storage spaces for logical units AA, BB, and CC), but the hardware disks on host-A 110 do not provide storage space for logical storage units DD and EE. Thus, a list of affected logical storage units is generated at the block 802 that includes logical storage units AA, BB, and CC listed therein.

The block 804 may be followed by a block 806 (“FOR EACH AFFECTED LOGICAL STORAGE UNIT IN THE LIST:”), wherein the method 800 loops through all of the affected logical storage units. This loop occurs at line 2 of Algorithm 5. Specifically at a block 808 (“GENERATE LIST OF DISKS OF THE LOGICAL STORAGE UNIT”) corresponding to line 3 of Algorithm 5, the method 800 generates a list of all of the underlying hardware disks for the logical storage unit. Thus, a list of all of the hardware disks for logical storage unit AA may be placed on the generated list at the block 808.

The block 808 may be followed by a block 810 (“REMOVE DISKS ON THE AFFECTED HOST FROM THE LIST OF DISKS”) corresponding to line 4 of Algorithm 5, wherein the method 800 removes the disks of the affected host-A 110A from the list of disks generated at the block 808, which is a result of a what-if host decommissioning operation. Such disks are removed from the list of disks since such disks are definitely not accessible after the host decommission operation is performed for host-A 110A.

The block 810 may be followed by a block 812 (“DETERMINE LEAST QUORUM FOR THE LOGICAL STORAGE UNIT”) corresponding to line 5 of Algorithm 5, wherein the method 800 determines, from the list of disks that has had the disks removed therefrom at the block 810, a least quorum value for the logical storage unit. The block 812 may be followed by a block 814 (“DETERMINE FAILURE RATE (PREDICTION)”) corresponding to line 6 of Algorithm 5, wherein the method 800 computes a failure prediction for the disks on the list having lost quorum, which for example is the least quorum value of the logical storage unit AA minus 1 disk. This computation of the failure prediction at the block 814 may be performed using Algorithm 2 previously described above.

This failure prediction at the block 814 is a prediction of a failure rate of the logical storage unit it the host is decommissioned (e.g., the failure prediction for logical storage unit AA if host-AA is decommissioned, in this example). All of the other affected logical storage units are at least in a reduced availability status (and possibly a failure status) after the host is decommissioned.

After the completion of the loops and generation of failure prediction(s) for the what-if operation, the method 800 proceeds to a block 816 (“PERFORM ACTION BASED ON PREDICTION”). The action performed can be similar to those described previously, including providing an alert or other prediction-related information to a user, so as to enable the user to determine whether or not to proceed with (or delay) the actual operation of decommissioning the host.

From the foregoing description, a more robust failure prediction is provided for logical storage units and corresponding hardware. The techniques described herein take into account the potential influence of disk status changes under different timing conditions in connection with providing failure predictions. The multi-head transformer techniques used by the machine-learning models described for disk failure prediction may based at least in part or entirely upon on the self-attention mechanism, which may be superior to traditional deep models with respect to timing for a series of tasks. For example, various embodiments of the method enable the parallel input of the disk information sequence (e.g., storage information), which greatly improves the learning efficiency. As another example, embodiments of this training method consider the impact of the disk health status at different times on itself and solves inherent long dependency issues. As still another example, compared to the traditional deep learning model, a multi-head transformer technique may be composed of self-attention components, with fewer parameters, and lower hardware requirements for implementations where fewer heads and layers are used for model training.

The embodiments disclosed herein also provide increased accuracy in the prediction of logical storage unit failures. The predictions of failure and/or reduced availability rates provided to users not only pertain to the disk's failure and reduced availability, but also predictions for the rate of the logical storage unit's failure and reduced availability. Such predictions are more useful to users of hyperconverged storage, in which the relationship between disk failure and logical storage unit failure may be rather complicated.

From the foregoing description, accurate prediction is also provided when a logical storage is undergoing an underlying topology/configuration change. For instance, the inflight underlying topology change is taken into consideration when computing a prediction of a failure or reduced availability. Such prediction during this time period is also reliable.

Still further, a more robust prediction is provided for what-if operations, such as what-if predictions on potential impact. The methods described herein may provide predictions on the direct impact to the logical storage unit, but also predict the possible logical storage unit failure due to incoming disk failures. The predictions provide users with more information for making decision with respect to capacity planning related tasks.

Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1 to 8.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term “processor” is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment and/or a distributed storage system), wherein it would be beneficial to provide improved predictions in connection with capacity planning, wherein the predictions take into account status changes of various component(s), timing of configuration change(s), etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other computer-readable instruction to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

We claim:

1. A method to evaluate an impact of a what-if operation for storage in a virtualized computing environment, the method comprising:
identifying the what-if operation and a host of the virtualized computing environment that is subject to the what-if operation and that provides hardware disks;
determine logical storage units in the virtualized computing environment that are affected by the what-if operation, wherein the logical storage units are supported by the hardware disks of the host and other hosts;
for each of the logical storage units:
generating a list of the hardware disks of the logical storage unit;
removing hardware disks of the host from the list of hardware disks of the logical storage unit; and
generating a prediction for hardware disks that remain on the list of hardware disks after the removal of the hardware disks of the host,
wherein the generated prediction is a failure prediction for the logical storage unit if an actual operation corresponding to the what-if operation is performed, and wherein other logical storage units are predicted to have at least a reduced availability in response to the what-if operation; and
performing an action based on the failure prediction.

2. The method of claim 1, wherein the what-if operation is a decommissioning of the host.

3. The method of claim 1, wherein generating the prediction includes:
obtaining a plurality of first predictions that correspond to a respective plurality of hardware disks in the virtualized computing environment, wherein each of the first predictions provide an individual failure prediction for a respective hardware disk amongst the plurality of hardware disks;
based on the plurality of first predictions, obtaining a second prediction that provides a failure prediction for a number of hardware disks amongst the plurality of hardware disks;
generating a third prediction, being the failure prediction, based on the second prediction and on a least quorum value for the hardware disks of the logical storage unit.

4. The method of claim 3, wherein the first, second, and third predictions are provided with respect to a prediction time frame.

5. The method of claim 3, wherein the first plurality of predictions are obtained using a transformer-based, multi-head machine learning model that receives statistics data, indicative of operation of the plurality of hardware disks over time, as input.

6. The method of claim 3, wherein generating the second prediction based on the plurality of first predictions includes:
generating a plurality of independent predictions for a corresponding plurality of failure events of hardware disks amongst the number of hardware disks; and
generating the second prediction by summing the plurality of independent predictions

7. The method of claim 1, wherein performing the action related to the capacity planning includes one or more of: generating an alert to provide a notification of a predicted failure or predicted reduced availability of the logical storage unit based on the what-if operation, initiating a procurement cycle to replace at least some of the hardware disks of the host, and providing a recommendation for a maintenance window for the logical storage unit.

8. A non-transitory computer-readable medium having instructions stored thereon, which in response to execution by one or more processors, cause the one or more processors to perform or control performance of a method to evaluate an impact of a what-if operation for storage in a virtualized computing environment, wherein the method comprises:
identifying a logical storage unit, in the virtualized computing environment, that is affected by the what-if operation, wherein the logical storage unit is supported by storage space of a number of hardware disks amongst a plurality of hardware disks in the virtualized computing environment;
determining a result of the what-if operation, which affects at least some of the number of hardware disks;
after determination of the result of the what-if operation, generating a prediction on availability of the logical storage unit; and
in response to the prediction on the availability, performing an action related to the what-if operation.

9. The non-transitory computer-readable medium of claim 8, wherein generating the prediction on the availability of the logical storage unit includes generating a prediction of a failure of the logical storage unit based on the result of the what-if operation.

10. The non-transitory computer-readable medium of claim 9, wherein the prediction of the failure is provided with respect to a prediction time frame and with respect to a least quorum number of hardware disks of the logical storage unit that remain available due to the result of the what-if operation.

11. The non-transitory computer-readable medium of claim 8, wherein performing the action related to the what-if operation includes one or more of: generating an alert to provide a notification of a predicted failure or predicted reduced availability of the logical storage unit, initiating a procurement cycle to replace at least some of the hardware disks of the logical storage unit, providing a recommendation to delay or cancel performance of an actual operation corresponding to the what-if operation, and providing a recommendation for a maintenance window for the logical storage unit.

12. The non-transitory computer-readable medium of claim 8, wherein the what-if operation is directed towards a host in the virtualized computing environment, and wherein the host provides at least some of the hardware disks that support the logical storage unit.

13. The non-transitory computer-readable medium of claim 12, wherein the what-if operation is a decommissioning of the host.

14. The non-transitory computer-readable medium of claim 8, wherein generating the prediction on the availability of the logical storage unit includes generating the prediction with respect to remaining hardware disks of the number of hardware disks, after the what-if operation has resulted in reduction of the number.

15. The non-transitory computer-readable medium of claim 8, wherein generating the prediction on the availability of the logical storage unit includes:
obtaining individual predictions of failures of the number of hardware disks, wherein the individual predictions of failures are obtained using a transformer-based, multi-head machine learning model; and
combining at least some of the individual predictions to generate the prediction on the availability of the logical storage unit.

16. A management server in a virtualized computing environment, the management server comprising:
one or more processors; and
a non-transitory computer-readable medium coupled to the one or more processors and having instructions stored thereon which, in response to execution by the one or more processors, cause the one or more processors to perform or control performance of operations that include:
identifying a logical resource, in the virtualized computing environment, that is affected by a what-if operation, wherein the logical resource is supported by hardware components in the virtualized computing environment;
generating a prediction on availability of the logical resource, wherein the prediction is based on hardware components that remain as a result of the what-if operation; and
in response to the prediction on the availability, performing an action related to the what-if operation.

17. The management server of claim 16, wherein the logical resource is a logical storage unit supported by storage space of a number of hardware disks, being the hardware components, amongst a plurality of hardware disks in the virtualized computing environment.

18. The management server of claim 16, wherein the prediction of the availability is provided with respect to a prediction time frame and with respect to a least quorum value of hardware components of the logical resource that remain available due to the result of the what-if operation.

19. The management server of claim 16, wherein generating the prediction on the availability of the logical resource includes:
obtaining individual predictions of failures of the number of hardware components, wherein the individual predictions of failures are obtained using a transformer-based, multi-head machine learning model; and
combining at least some of the individual predictions to generate the prediction on the availability of the logical resource.

20. The management server of claim 16, wherein the what-if operation is a decommissioning of a host that provides at least some of the hardware components that support the logical resource.
